(19) United States
(12) Patent Application Publication
(10) Pub. No.: US 2024/0359936 A1
(43) Pub. Date: Oct. 31, 2024

(54) TIE-DOWN CAPABLE OF AUTOMATICALLY REELING A STRAP AT PROPER SPEED

(71) Applicant: Ping-Chun Huang, Taichung City (TW)

(72) Inventor: Ping-Chun Huang, Taichung City (TW)

(21) Appl. No.: 18/139,341

(22) Filed: Apr. 25, 2023

(51) Int. Cl. B65H 18/10; B65H 75/44

(52) U.S. Cl. CPC B65H 18/10; B65H 75/4442; B65H 75/4481

(57) ABSTRACT

A tie-down includes a frame, a handle, a reel, a driving detent, a retaining detent and a brake. In a manual mode, the handle is pivoted back and forth on the frame to make the detents alternately engage with two ratcheted wheels of the reel to reel a strap. To switch the tie-down to an automatic mode, the handle is lifted to disengage the detents from the ratcheted wheels to allow a coil spring to rotate the reel to reel the strap. The brake is in contact with the ratcheted wheels to render the reeling at proper speed. The brake is directly movable away from the ratcheted wheels to allow the coil spring to further rotate the reel to completely reel the strap.

### BACKGROUND OF INVENTION

### 1. Field of Invention

The present invention relates to a tie-down and, more particularly, to a tie-down capable of automatically reeling a strap at proper speed.

### 2. Related Prior Art

Chinese Patent No. 2871975 discloses a conventional tie-down including a frame 10, a handle 20, a reel 30 and a coil spring 40. A spring-loaded detent 14 is connected to the frame 10. A spring-biased detent 23 is connected to the handle 20. The reel 30 includes a tube 31 connected to two toothed wheels 32 engageable with the spring-loaded detents 14 and 23. An end of a strap 91 is connected to a hook. Another end of the strap 91 is connected to an axle 13 including two lateral sections connected to the frame 10 and a middle section inserted in the tube 31. An end of the coil sprig 40 is connected to the axle 13. Another end of the coil spring 40 is indirectly connected to the frame 10. The coil spring 40 is loaded when the strap 91 is released from the tube 31. This conventional tie-down is switched between an automatic mode and a manual mode.

In the manual mode, the handle 20 is pivoted to position on the frame 10. The spring-loaded detent 23 engages with the toothed wheels 32, thereby reeling the strap 91 on the tube 31. Then, the handle 20 is pivoted toward the frame 10, the spring-loaded detent 23 rattles on the toothed wheels 32, without releasing the strap 91 from the tube 31.

In the automatic mode, the handle 20 is pivoted to another position on the frame 10 to disengage the spring-biased detent 23 from the toothed wheels 32, thereby allowing the coil spring 40 to rotate the toothed wheels 32 via the axle 13 to reel the strap 91. However, in the beginning, the automatic reeling of the strap 31 goes at high speed so that the strap 91 and/or the hook might hurt someone or break something.

Chinese Patent No. 100391645C discloses a conventional tie-down like the tie-down disclosed in Chinese Patent No. 2871975 except for including a brake assembly 6 to reduce the speed of the reeling of the strap. The brake assembly 6 includes a brake 61 loaded by a spring 62.

In an automatic mode, in a first phase (FIG. 8), a detent 31 connected to a handle 2 is disengaged from two toothed wheels of a reel 9 that reels a strap 14. The brakes 61 are in contact with the toothed wheels of the reel 9. Thus, the speed of the reeling of the strap 14 is not excessively high. In a second phase (FIG. 9), the handle 2 is pivoted downward so that the detent 31 disengages the brake 61 from the toothed wheels of the reel 9. Thus, the reeling of the strap 14 can be complete. The disengagement of the brake 61 is however indirect and sometimes ineffective, thereby rendering the reeling of the strap 14 incomplete.

U.S. Pat. No. 8,312,601 discloses a conventional tie-down including a frame 10, a handle 20, a reel 30, a withdrawing unit 40 and two spring-biased detents 50 and 60. The handle 20 is pivotally connected to the frame 10. The reel 30 includes two ratcheted wheels 32 and is rotationally connected to the frame 10. The spring-biased detent 50 is movably connected to the frame 10. The spring-biased detent 60 is movably connected to the handle 20. In a manual mode, the handle 20 is pivoted on the frame 10 so that the spring-biased detents 50 and 60 alternatively engage with the ratcheted wheels 32. In an automatic mode, the spring-biased detent 50 is moved away from the ratcheted wheels 32 and the spring-biased detent 60 is allowed to rattle on the ratcheted wheels 32 to allow the withdrawing unit 40 to rotate the reel 30. The spring-biased detent 60 is used as a brake in the automatic mode.

The present invention is therefore intended to obviate or at least alleviate the problems encountered in the prior art.

### SUMMARY OF INVENTION

It is the primary objective of the present invention to provide a tie-down capable of automatically reeling a strap at proper speed.

To achieve the foregoing objective, the tie-down includes a frame, a handle, an axle, a reel, a strap, a driving detent, a retaining detent and a brake. The frame includes two lateral plates each of which comprises a slit, an orifice, a bore between the orifice and the slit, and an edge formed with a manual-mode section and a cutout above the bore. The axle is inserted in the bores of the lateral plates. The reel includes a tube for receiving the axle and two ratcheted wheels connected to the tube. The strap is wound around the tube. The retaining detent is movable along the slits of the lateral plates and normally in elastic engagement with the ratcheted wheels. The brake is pivotally connected to the frame and normally in elastic contact with the ratcheted wheels. The handle is formed with two cams each of which comprises a slit. The driving detent is movable along the slits of the cams and operable for elastic contact with the edges of the lateral plates so that two portions of the driving detent are moved along the edges of the lateral plates when the handle is switched between a manual mode and an automatic mode. In the manual mode, the handle is pivoted back and forth on the base to move the driving detent back and forth along the automatically reeling sections of the edges of the lateral plates to allow the driving and retaining detents to alternately engage with the ratcheted wheels when the brake is in elastic contact with the ratcheted wheels. In the automatic mode, the driving detent is inserted in the cutouts of the lateral plates so that the driving and retaining detents are disengaged from the ratcheted wheels, leaving the brake in elastic contact with the ratcheted wheels to slow the reeling, wherein direct access to the brake is allowed to move the brake away from the ratcheted wheels not to slow the reeling.

Other objective, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of tie-down capable of automatically reeling a strap at proper speed according to the preferred embodiment of the present invention;

FIG. 2 is a top view of the tie-down shown in FIG. 1;

FIG. 3 is a perspective view of a frame of the tie-down shown in FIG. 1;

FIG. 4 is a perspective view of a handle of the tie-down depicted in FIG. 1;

FIG. 5 is a perspective view of a brake of the tie-down shown in FIG. 1;

FIG. 6 is a perspective view of a spring for biasing the brake shown in FIG. 5;

FIG. 7 is a cross-sectional view of the tie-down taken along a line A-A shown in FIG. 2;

FIG. 8 is a cross-sectional view of the tie-down taken along a line B-B shown in FIG. 2; and

FIG. 9 is a cross-sectional view of the tie-down in another position than shown in FIG. 1.

### DETAILED DESCRIPTION OF PREFERRED EMBODIMENT

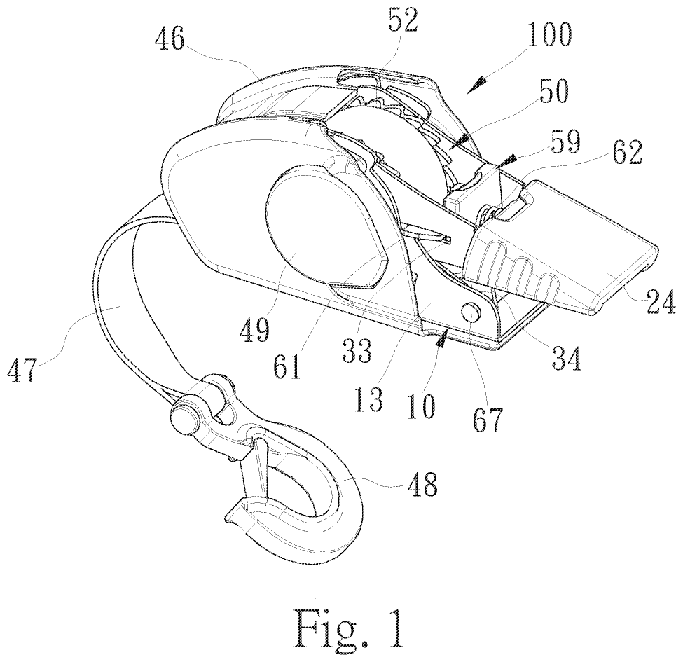

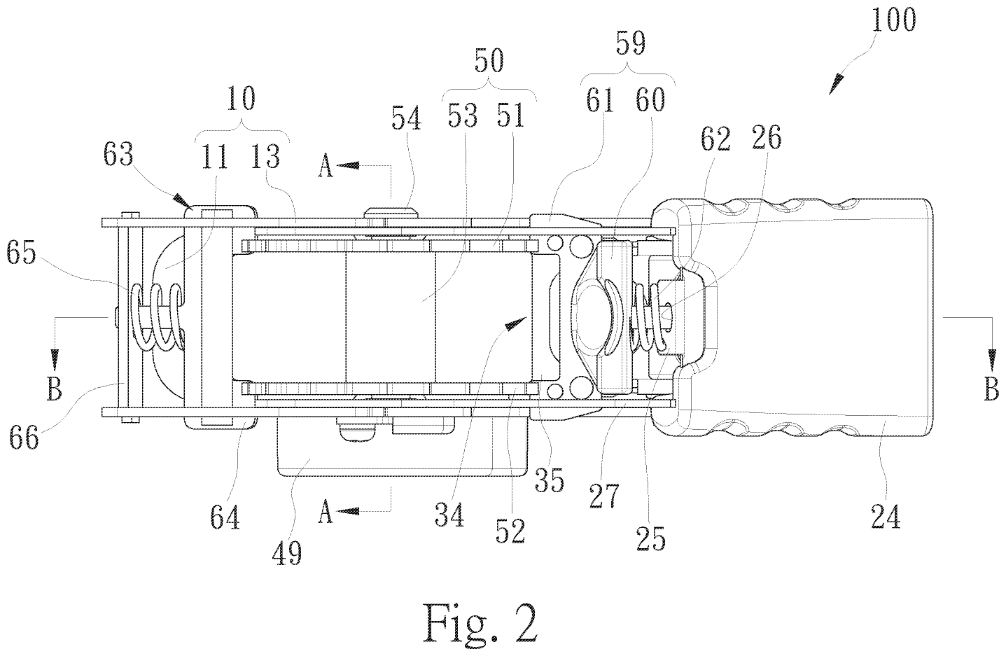

Referring to FIGS. 1 and 2, a tie-down 100 includes a frame 10, a handle 24, a reel 50, a coil spring 57, a driving detent 59, a retaining detent 63 and a brake 34 in accordance with the preferred embodiment of the present invention. The reel 50 is rotationally supported on the frame 10 by an axle 54. The reel 50 includes a tube 53 formed between two ratcheted wheels 51. Namely, each of the ratcheted wheels 51 includes ratchets 52 along a circular edge. The tube 53 extends around the axle 54. The reel 50 is partially covered by a major shell 46 connected to the frame 10.

The handle 24 is pivotally connected to the frame 10. The driving detent 59 is movably connected to the handle 24. The retaining detent 63 is movably connected to the frame 10. The brake 34 is pivotally connected to the frame 10 by an axle 67.

In a manual mode, the handle 24 is pivoted back and forth on the frame 10 to allow the detents 59 and 63 to alternately engage with the ratcheted wheels 51 to reel a strap 47 including an end tied to the axle 54 and another end tied to a hook 48.

To switch the tie-down 100 to an automatic mode, the handle 24 is pivoted on the frame 10 to a position to be described to disengage the detents 59 and 63 from the ratcheted wheels 51 to allow the coil spring 57 to rotate the reel 50 to reel the strap 47. In a first phase, the brake 34 is in elastic contact with the ratcheted wheels 51 to render the reeling at proper speed. In a second phase, the brake 34 is directly moved away from the ratcheted wheels 51 to allow the coil spring 57 to further rotate the reel 50 to completely reel the strap 47.

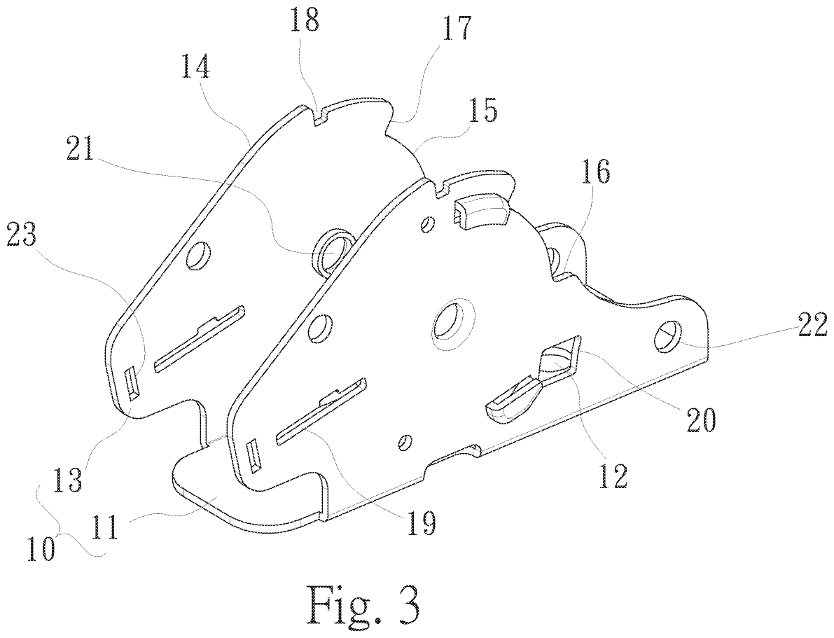

Referring to FIG. 3, the frame 10 includes a base 11 being a rectangular plate formed between two lateral plates 13. The base 11 is made with an aperture 12 for receiving a fastener (not shown) such as a rivet or a threaded bolt inserted in an external object such as a wall. Each of the lateral plates 13 includes an automatic-mode cutout 18, a slit 19, an orifice 20, a bore 21, a hole 22 and a slot 23. The bore 21 receives a section of the axle 54. The automatic-mode cutout 18 is made in an edge 14 of each of the lateral plates 13 and located above the bore 21. The edge 14 of each of the lateral plates 13 includes a recessed manual-mode section 15 adjacent to the automatic-mode cutout 18. An end of the manual-mode section 15 is taken as a start 16 and another end of the manual-mode section 15 is taken as a finish 17. The start 16 is located substantially above the orifice 20. The finish 17 is located adjacent to the automatic-mode cutout 18.

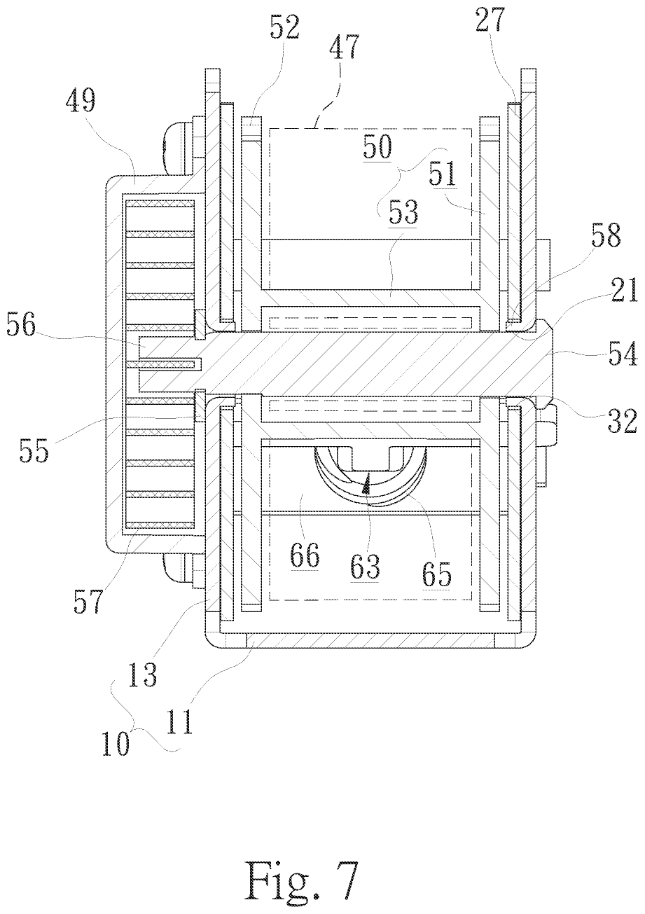

Referring to FIG. 7, the axle 54 includes a split end 56 and an enlarged end (not numbered). The split end 56 and the enlarged end of the axle 54 are located beyond the lateral plates 13. A C-clip 55 is engaged with a section of the axle 54 near the split end 56. Thus, the axle 54 is kept on the frame 10. The split end 56 is inserted in a shell 49 connected to one of the lateral plates 13 by screws for example. The minor shell 49 contains a coil spring 57 including an end connected to the split end 56 and another end connected to an internal portion of the shell 49.

The ratcheted wheels 51 are made independent of the tube 53. However, the ratcheted wheels 51 are connected to two ends of the tube 53 as disclosed in Chinese Patent No. 2871975.

Referring to FIGS. 2 and 3, the retaining detent 63 is in the form of a T-shaped plate including a longitudinal portion and a transverse portion. The longitudinal portion of the retaining detent 63 is inserted in a spring 65 and a plank 66. The plank 66 includes two ends inserted in the slots 23 of the lateral plates 13. The spring 65 is compressed between the plank 66 and the transverse portion of the retaining detent 63 so that the retaining detent 63 tends to move toward the reel 50. The retaining detent 63 includes two horns 64 movably inserted in slits 19 of the lateral plates 13. The slits 19 guide the horns 64 to engage with the ratcheted wheels 51 so that the reel 50 is not allowed to release the strap 47. The horns 64 contact the ratcheted wheels 51 to reduce torque exerted by the coil spring 57 for reeling the strap 47.

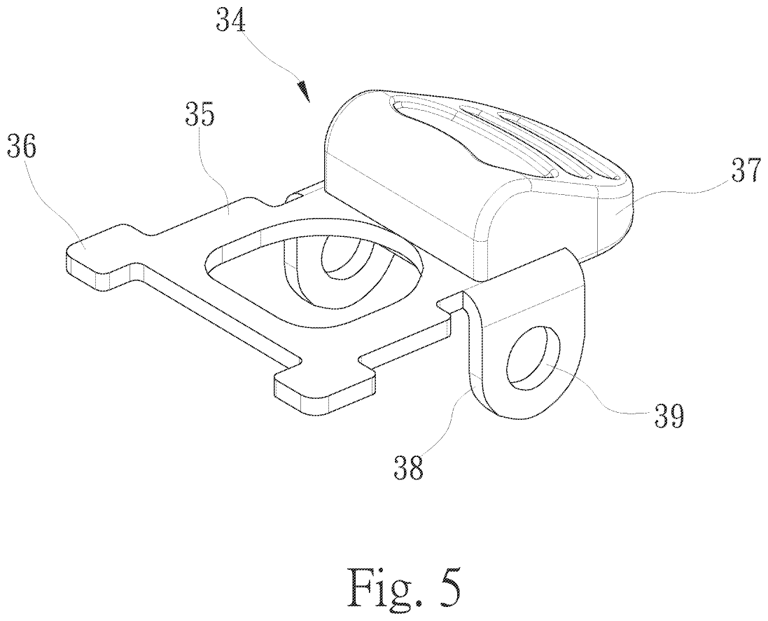

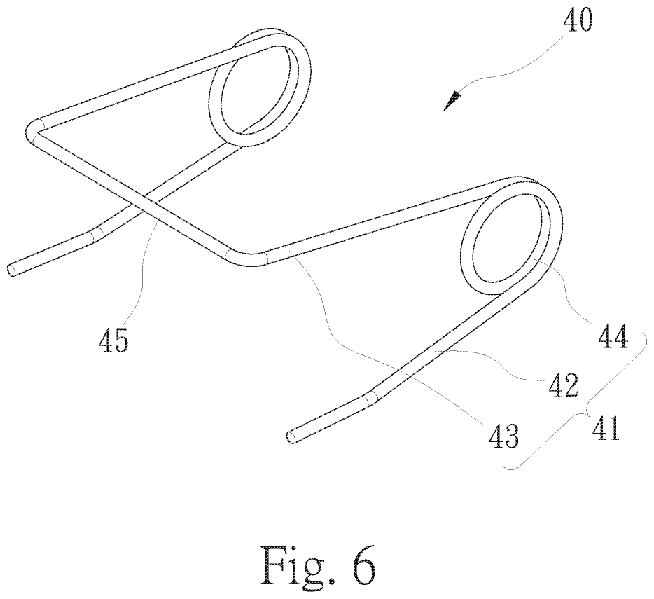

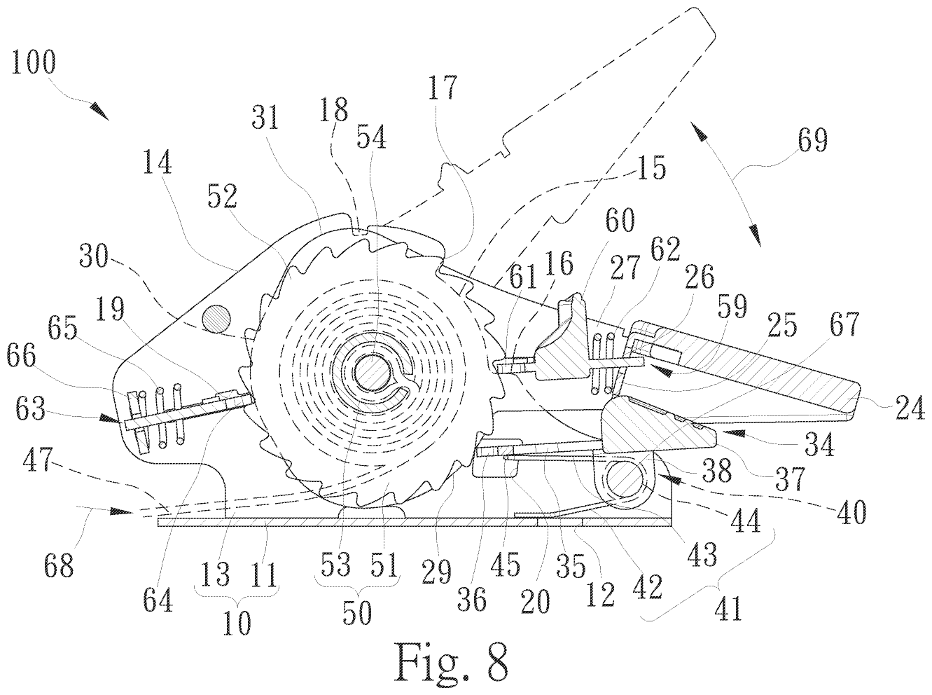

Referring to FIGS. 5, 6 and 8, the brake 34 includes a plate 35, two horns 36 extending forward from the plate 35, a lever 37 extending backward from the plate 35, and two lugs 38 extending downward from the plate 35. Namely, each of the lugs 38 includes a bore 39 for receiving a section of the axle 67. The horns 36 are movable in the orifices 20 of the lateral plates 13 respectively. Thus, the brake 34 is pivotally connected to the lateral plates 13 on the base 11.

Preferably, the brake 34 is loaded by a double spring 40 including two torque springs 41 interconnected by a connective section 45. Each of the torque springs 41 two rectilinear sections 42 and 43 interconnected by a helical section 44. The rectilinear sections 43 of the torque springs 41 extend from the connective section 45.

The helical sections 44 extend around the axle 67, beyond the lugs 38. The rectilinear sections 42 are in contact with an upper face of the base 11 and the second rectilinear sections 43 and the connective section 45 are in contact with a lower face of the plate 35. Thus, the horns 36 tend to move upward in the orifices 20 of the lateral plates 13. The horns 36 contact the ratcheted wheels 51 and help prevent the coil spring 57 from rotating the reel 50.

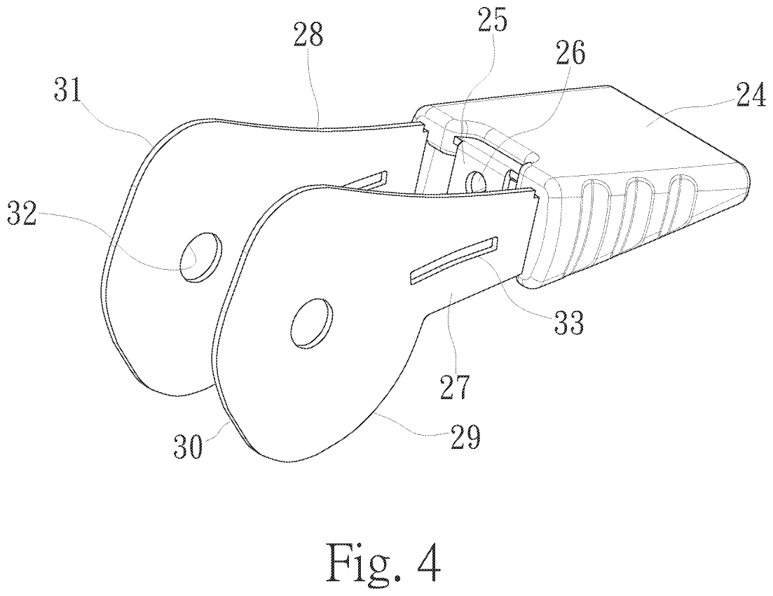

Referring to FIGS. 4, 7 and 8, the handle 24 includes a bent portion 25 formed between two cams 27. The bent portion 25 includes an aperture 26. The cams 27 are identical to each other in shape. Each of the cams 27 includes a bore 32 and a slit 33. The bore 32 is located further from the bent portion 25 than the slit 33 is. Each of the cams 27 is formed with an edge 28 extending around the bore 32. The edge 28 includes three sections 29, 30 and 31.

In assembly, a collar 58 formed on each of the lateral plates 13 is inserted in the bore 32 of a corresponding one of the cams 27. The axle 54 is inserted in the collars 58 of the lateral plates 13.

Referring to FIGS. 1, 2 and 8, the driving detent 59 is also in the form of a T-shaped plate including a longitudinal portion and a transverse portion. The longitudinal portion of the driving detent 59 extends in the aperture 26 of the bent portion 25 through a spring 62. The spring 62 is compressed between the bent portion 25 and a handle 60 of the driving detent 59 so that the driving detent 59 tends to move toward the reel 50. The driving detent 59 includes two horns 61 respectively movable in and along the slits 33 of the cams 27. The slits 33 guide the horns 61 toward or from the edges 14 of the lateral plates 13 to allow operation of the handle 24 to switch between the manual mode and the automatic mode.

In the manual mode, the driving detent 59 rests on the manual-mode sections 15 of the lateral plates 13, and the horns 61 abut against the starts 16 and engage with the ratcheted wheels 51. The retaining detent 63 is pointed at the sections 30 of the cams 27. The sections 30 of the cams 27 are lower than the ratchets 52 of the ratcheted wheels 51 so that the horns 64 engage with the ratchets 52. The double spring 40 pushes the plate 35 of the brake 34 to move the horns 36 upward in the orifices 20 of the lateral plates 13. Thus, the horns 36 are allowed to contact the sections 29 of the cams 27 and engage with the ratchets 52.

As indicated by an arrow head 69, the handle 24 is pivoted upward to move the horns 61 to the finishes 17 of the manual-mode sections 15 of the edges 14 of the lateral plates 13 from the starts 16. The horns 61 move the ratchets 52 of the reel 50 to rotate the tube 53 in a reeling direction 68 to reel the strap 47 for a section equivalent to three ratchets 52. Then, the handle 24 is pivoted downward to make the horns 61 rattle on the ratchets 52 of the reel 50 to return to the starts 16 of the manual-mode sections 15 of the edges 14 of the lateral plates 13 from the finishes 17. Meanwhile, the retaining detent 63 engages with ratchets 52 to prevent the reel 50 from rotation that would otherwise releases the strap 47. The brake 34 contact the ratchets 52 to resist the coil spring 57, which tend to rotate the reel 50 to reel the strap 47.

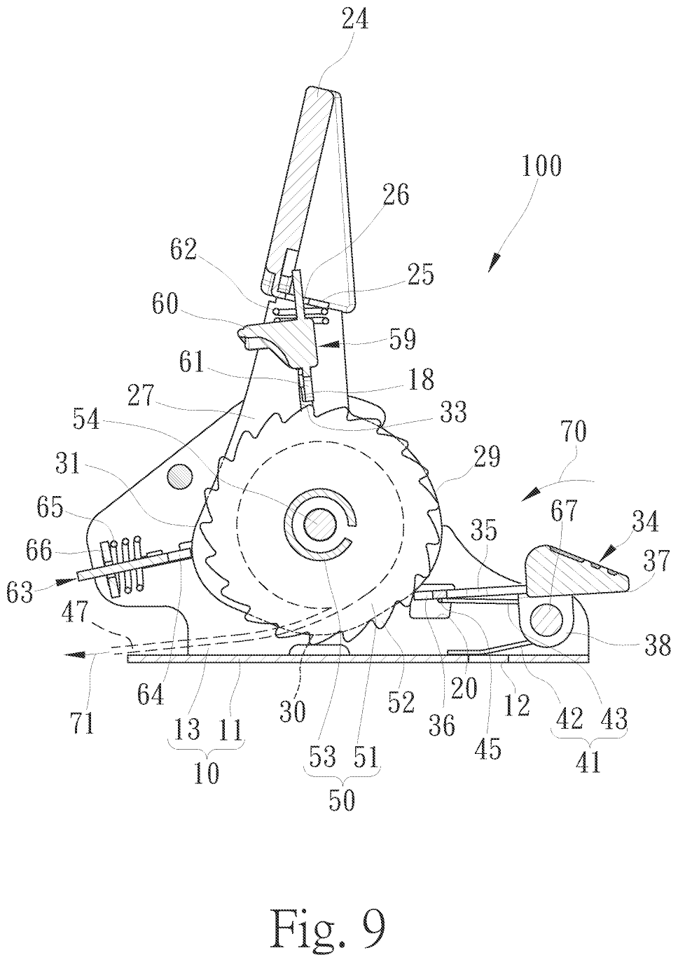

Referring to FIG. 9, the tie-down 100 is in the automatic mode. To this end, the handle 24 is pivoted upward to move the horns 61 into the automatic-mode cutouts 18 of the lateral plates 13 from the manual-mode sections 15 of the edges 14 of the lateral plates 13. The handle 24 extends substantially vertically above the base 11. The handle 60 compresses the spring 62. The sections 31 of the edges 28 of the cams 27 are higher than the ratchets 52 to keep the retaining detent 63 from ratchets 52 of the ratcheted wheels 51.

In the first phase, the sections 30 of the edges 28 of the cams 27 face the brake 34 to make the horns 36 contact the ratchets 52 to resist the torque exerted on the reel 50 by coil spring 57, thereby preventing the reel 50 from releasing the strap 47.

In the second phase, the lever 37 is lifted on the frame 10 to move the horns 36 from the ratchets 52. Thus, the brake 34 does not resist the torque exerted on the reel 50 by the coil spring 57, thereby allowing the coil spring 57 to completely reel the strap 47.

However, it should be noted that the strap 47 can in fact be released from the reel 50 in a releasing direction 71 although the tie-down 100 is in the so-called automatic mode.

The tie-down 100 is advantageous for at least two reasons.

Firstly, in the manual mode, the handle 24 is located at the starts 16 so that the brake 34 cannot stop the reeling.

Secondly, in the automatic mode, as indicated by an arrow head 70, the handle 24 is lifted on the frame 10 to allow the brake 34 to be directly lifted and hence disabled.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A tie-down comprising:
a frame comprising two lateral plates each of which comprises a slit, an orifice, a bore between the orifice and the slit, and an edge formed with a manual-mode section and an automatic-mode cutout above the bore;
a first axle inserted in the bores of the lateral plates;
a reel comprising a tube for receiving the first axle and two ratcheted wheels connected to the tube;
a strap wound around the tube;
a retaining detent movable along the slits of the lateral plates and normally in elastic engagement with the ratcheted wheels;
a brake pivotally connected to the frame and normally in elastic contact with the ratcheted wheels;
a handle formed with two cams each of which comprises a slit; and
a driving detent movable along the slits of the cams and operable for elastic contact with the edges of the lateral plates so that two portions of the driving detent are moved along the edges of the lateral plates when the handle is switched between a manual mode and an automatic mode;
wherein in the manual mode, the handle is pivoted back and forth on the base to move the driving detent back and forth along the automatically reeling sections of the edges of the lateral plates to allow the driving and retaining detents to alternately engage with the ratcheted wheels when the brake is in elastic contact with the ratcheted wheels;
wherein in the automatic mode, the driving detent is inserted in the automatic-mode cutouts of the lateral plates so that the driving and retaining detents are disengaged from the ratcheted wheels, leaving the brake in elastic contact with the ratcheted wheels to slow the reeling, wherein direct access to the brake is allowed to move the brake away from the ratcheted wheels not to slow the reeling.

2. The tie-down according to claim 1, further comprising a second axle for pivotally connecting in the brake to the lateral plates.

3. The tie-down according to claim 1, wherein the brake comprises a plate and two lugs extending downward from the plate, wherein each of the lugs comprises a bore for receiving a portion of the second axle.

4. The tie-down according to claim 3, wherein the brake further comprises two horns extending forward from the plate to contact the ratcheted wheels.

5. The tie-down according to claim 4, wherein the brake further comprises a lever extending backward from the plate, wherein the lever is liftable to move the horns from the ratcheted wheels.

6. The tie-down according to claim 3, further comprising a double spring comprising a connective section in contact with the plate and two torque springs each of which comprises a first rectilinear section extending from the connective section, a second rectilinear section in contact with the frame, and a helical section formed between the first and second rectilinear sections.
